(19) United States
(12) Patent Application Publication
(10) Pub. No.: US 2024/0039803 A1
(43) Pub. Date: Feb. 1, 2024

(54) OFFLOADING STATEFUL SERVICES FROM GUEST MACHINES TO HOST RESOURCES

(71) Applicant: VMware, Inc., Palo Alto, CA (US)

(72) Inventors: Peng Li, Fremont, CA (US); Guolin Yang, San Jose, CA (US); Ronak Doshi, San Jose, CA (US); Boon Seong Ang, Saratoga, CA (US); Wenyi Jiang, Fremont, CA (US)

(21) Appl. No.: 17/876,452

(22) Filed: Jul. 28, 2022

(51) Int. Cl. H04L 41/40; H04L 41/50

(52) U.S. Cl. CPC H04L 41/40; H04L 41/50

(57) ABSTRACT

Some embodiments of the invention provide a method for offloading one or more data message processing services from a machine executing on a host computer. The method is performed by the machine. The method uses a set of virtual resources allocated to the machine to perform a set of services for a first set of data messages belonging to a particular data message flow. The method determines that for a second set of data messages belonging to the particular data message flow, the set of services should be performed by a virtual network interface card (VNIC) that executes on the host computer and is attached to the machine. Based on the determination, the method directs the VNIC to perform the set of services for the second set of data messages. The VNIC uses resources of the host computer to perform the set of services for the second set of data messages.

### BACKGROUND

Today, stateful services (e.g., firewall services, load balancing services, encryption services, etc.) running inside guest machines (e.g., guest virtual machines (VMs)) can be very expensive, particularly for applications that need to handle large volumes of firewall, load balancing, and VPN (virtual private network) traffic. In some such cases, these stateful services can cause bottlenecks for datacenter traffic going in and out of the datacenter, and result in significant negative impacts on customer experiences. Additionally, service-critical guest machines may need to migrate from one host to another, and need to maintain service capability and throughput before and after the migration such that from a user perspective, the service is not only uninterrupted, but also performant.

### BRIEF SUMMARY

Some embodiments of the invention provide a method for offloading one or more data message processing services from a machine (e.g., a virtual machine (VM)) executing on a host computer. At the machine, the method uses a set of virtual resources allocated to the machine to perform a set of services for a first set of data messages. The method determines that the allocated set of virtual resources is being over-utilized, and directs a virtual network interface card (VNIC) that executes on the host computer and that is attached to the machine to perform the set of services for a second set of data messages using resources of the host computer.

In some embodiments, the second set of data messages are data messages that belong to a particular data message flow, and the VNIC receives configuration data for the data message flow along with a set of service rules defined for the particular data message flow through a communications channel between the machine and the VNIC. The configuration data and set of services rules are sent from the machine to the VNIC as control messages, in some embodiments. When the VNIC determines that a first data message received at the VNIC belongs to the particular data message flow and matches at least one service rule in the set of service rules, the VNIC performs a service specified by the at least one service rule on the first data message before forwarding the data message to its destination. In some embodiments, the destination is the machine, and the VNIC provides the processed data message to the machine. Also, in some embodiments, the destination is an element external to the machine, such as another machine on the host computer or a machine external to the host computer, and the VNIC forwards the processed data message to the external destination.

The machine, in some embodiments, determines that its allocated set of virtual resources is being over-utilized upon determining that a particular quality of service (QoS) metric has exceeded or has failed to meet a specified threshold. In some embodiments, for example, a threshold associated with throughput may be specified for the machine, and when the machine is unable to meet that threshold for throughput, the machine begins to direct the VNIC to perform one or more services on one or more data message flows associated with the machine. In some embodiments, the machine may direct the VNIC to perform one or more services for data message flows of a certain priority level (e.g., all data message flows having a low priority or all data message flows having a high priority, etc.), while the machine continues to perform the one or more services for all other data message flows.

In some embodiments, the VNIC determines that a data message belongs to a flow for which the VNIC is directed to perform one or more services by matching a flow identifier from a header of the data message with a flow identifier specified by one or more of the service rules provided by the machine. Each service rule specifies one or more actions (i.e., services) to be performed on data messages that match to the service rule. Accordingly, upon matching the data message's flow identifier to a service rule, the VNIC of some embodiments performs one or more actions specified by the service rule on the data message.

The services that the machine offloads to the VNIC, in some embodiments, are stateful services. In some embodiments, these stateful services include middlebox services such as firewall services, load balancing services, IPsec (Internet protocol security) services (e.g., authentication and encryption services), and encapsulation and decapsulation services. For instance, in some embodiments, a firewall service may include a connection tracking service. In some embodiments, when the host computer on which the machine executes includes a physical NIC (PNIC) (i.e., a hardware NIC), the one or more services offloaded to the VNIC may be further offloaded to the PNIC. The PNIC, in some embodiments, is a smartNIC.

In some embodiments, as mentioned above, the services offloaded to the VNIC are stateful services. The machine, in some embodiments, initially owns state data for data messages serviced by the VNIC, while the VNIC itself maintains copies of the state data when the offloading is initialized or reconfigured. In some embodiments, if the machine is migrated from the host computer to another host computer, the state data is saved with the VNIC on the source host computer, and subsequently restored on a VNIC executing on the destination host computer, which can continue performing stateful services that were previously offloaded to the VNIC executing on the source host computer.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 conceptually illustrates a host computer of some embodiments on which a machine and a VNIC execute.

FIG. 2 illustrates virtualization software of some embodiments that includes a virtual switch, a service virtual machine, and a VNIC that includes components for performing services offloaded from the VM.

FIG. 3 illustrates virtualization software of some embodiments that includes a virtual switch, a VM, a DFW engine, and a VNIC that includes components for performing services offloaded from the VM.

FIG. 4 illustrates an example of virtualization software that executes multiple SVMs each having a respective VNIC to which services can be offloaded, in some embodiments.

FIG. 5 illustrates a host computer that includes virtualization software and a PNIC that includes components for performing offloaded services, in some embodiments.

FIG. 6 conceptually illustrates an example embodiment of a smartNIC.

FIG. 7 conceptually illustrates a process performed by a machine in some embodiments to offload one or more services to a VNIC.

FIG. 8 conceptually illustrates different data message flows being directed to either a VM or VNIC executing on a host computer, according to some embodiments.

FIG. 9 conceptually illustrates an example in which different inbound flows are processed by the PNIC, VNIC, and VM, according to some embodiments.

FIG. 10 conceptually illustrates an example in which various outbound flows are serviced by the VM, VNIC, and PNIC, in some embodiments.

FIG. 11 conceptually illustrates a process performed by a VNIC of some embodiments that executes on a host computer and performs services on data messages sent to and from a machine executing on the host computer.

FIG. 12 conceptually illustrates a process performed in some embodiments when migrating a machine that has offloaded services to a VNIC from one host computer (i.e., source host computer) to another host computer (i.e., destination host computer).

FIG. 13 conceptually illustrates an example of some embodiments of a VM being migrated from one host to another.

FIG. 14 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for offloading one or more data message processing services from a machine (e.g., a virtual machine (VM)) executing on a host computer. At the machine, the method uses a set of virtual resources allocated to the machine to perform a set of services for a first set of data messages. The method determines that the allocated set of virtual resources is being over-utilized, and directs a virtual network interface card (VNIC) that executes on the host computer and that is attached to the machine to perform the set of services for a second set of data messages using resources of the host computer.

In some embodiments, the second set of data messages are data messages that belong to a particular data message flow, and the VNIC receives configuration data for the data message flow along with a set of service rules defined for the particular data message flow through a communications channel between the machine and the VNIC. The configuration data and set of services rules are sent from the machine to the VNIC as control messages, in some embodiments. When the VNIC determines that a first data message received at the VNIC belongs to the particular data message flow and matches at least one service rule in the set of service rules, the VNIC performs a service specified by the at least one service rule on the first data message before forwarding the data message to its destination. In some embodiments, the destination is the machine, and the VNIC provides the processed data message to the machine. Also, in some embodiments, the destination is an element external to the machine, such as another machine on the host computer or a machine external to the host computer, and the VNIC forwards the processed data message to the external destination.

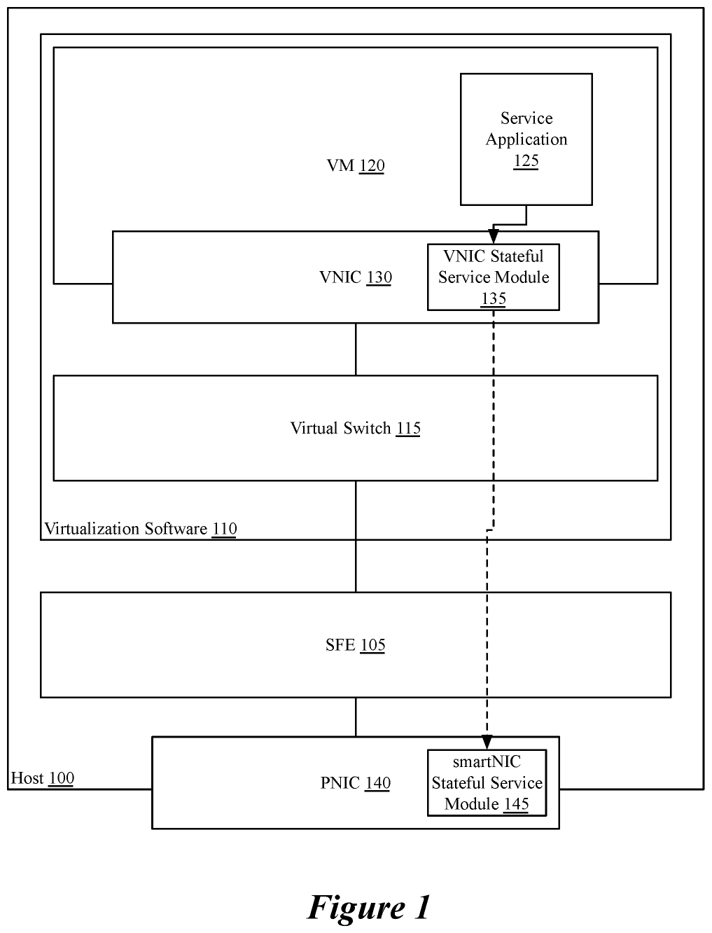

FIG. 1 conceptually illustrates a host computer of some embodiments on which a machine and a VNIC execute. As shown, the host computer 100 includes a software forwarding element (SFE) 105, a PNIC 140, and virtualization software 110, which runs a service VM (SVM) 120, a VNIC 130, and a virtual switch 115.

The VNIC 130 is responsible for exchanging messages between its SVM 120 and the SFE 105. In some embodiments, the SVM 120 is one of multiple VMs executing in the virtualization software 110 on the host computer 100, with each VM having its own respective VNIC for exchanging data messages between their VMs and the virtual switch 115. In some such embodiments, each VNIC connects to a particular interface of the virtual switch 115. The virtual switch 115 also connects to the SFE 105, which also connects to a physical network interface card (PNIC) 140 of the host computer 100. In some embodiments, the VNICs are software abstractions created by the virtualization software 110 of one or more PNICs 140 of the host.

The SFE 105 connects to the host PNIC 140 (through a NIC driver [not shown]) to send outgoing messages and to receive incoming messages. In some embodiments, the SFE 105 is defined to include a port (not shown) that connects to the PNIC's driver to send and receive messages to and from the PNIC. The SFE 105 performs message-processing operations to forward messages that it receives on one of its ports to another one of its ports. For example, in some embodiments, the SFE 105 tries to use data in the message (e.g., data in the message header) to match a message to flow-based rules, and upon finding a match, to perform the action specified by the matching rule (e.g., to hand the message to one of its ports which directs the message to be supplied to a destination VM via the virtual switch 115 or to the PNIC 140).

In some embodiments, the SFE 105 is a software switch, while in other embodiments it is a software router or a combined software switch/router. The SFE 105, in some embodiments, implements one or more logical forwarding elements (e.g., logical switches or logical routers) with SFEs executing on other hosts in a multi-host environment. A logical forwarding element, in some embodiments, can span multiple hosts to connect DCNs (e.g., VMs, containers, pods, etc.) that execute on different hosts but belong to one logical network. Similarly, the virtual switch 115 of some embodiments spans multiple host computers to connect DCNs belonging to the same logical network, as well as DCNs belonging to various different subnets (e.g., to connect DCNs belonging to one subnet to DCNs belonging to a different subnet).

Different logical forwarding elements can be defined to specify different logical networks for different users, and each logical forwarding element can be defined by multiple software forwarding elements on multiple hosts. In some embodiments, for instance, the virtual switch 115 is defined by the SFE 105. Each logical forwarding element isolates the traffic of the DCNs of one logical network from the DCNs of another logical network that is serviced by another logical forwarding element. A logical forwarding element can connect DCNs executing on the same host and/or different hosts, both within a datacenter and across datacenters. In some embodiments, the SFE 105 and the virtual switch 115 extract from a data message a logical network identifier (e.g., a VNI) and a MAC address. The SFE 105 and virtual switch 115 in these embodiments use the extracted VNI to identify a logical port group, and then uses the MAC address to identify a port within the port group.

The virtualization software 110 (e.g., a hypervisor) serves as an interface between SVM 120 and the SFE 105, in some embodiments, as well as other physical resources (e.g., CPUs, memory, etc.) available on host machine 100, in some embodiments. The architecture of the virtualization software 110 may vary across different embodiments of the invention. In some embodiments, the virtualization software 110 can be installed as system-level software directly on the host computer 100 (i.e., a “bare metal” installation) and be conceptually interposed between the physical hardware and the guest operating systems executing in the VMs. In other embodiments, the virtualization software 110 may conceptually run “on top of” a conventional host operating system in the server.

In some embodiments, the virtualization software 110 includes both system-level software and a privileged VM (not shown) configured to have access to the physical hardware resources (e.g., CPUs, physical interfaces, etc.) of the host computer 100. While the VNIC 130 is shown as included in the SVM 120, the VNIC 130 in other embodiments is implemented by the code (e.g., VM monitor code) of the virtualization software 110. In still other embodiments, the VNIC 130 is partly implemented in its associated VM and partly implemented by the virtualization software executing on its VM's host computer. In some embodiments, the VNIC 130 is a software implementation of a physical NIC. In some of these embodiments, the VNIC serves as the virtual interface that connects its VM to a virtual forwarding element (e.g., the virtual switch 115), in the same manner that a PNIC serves as the physical interface through which a physical compute connects to a physical forwarding element (e.g., a physical switch). The virtual switch 115 is connected to the SFE 105, which connects to the PNIC 140, in order to allow network traffic to be exchanged between elements (e.g., the SVM 120) executing on host machine 100 and destinations on an external physical network.

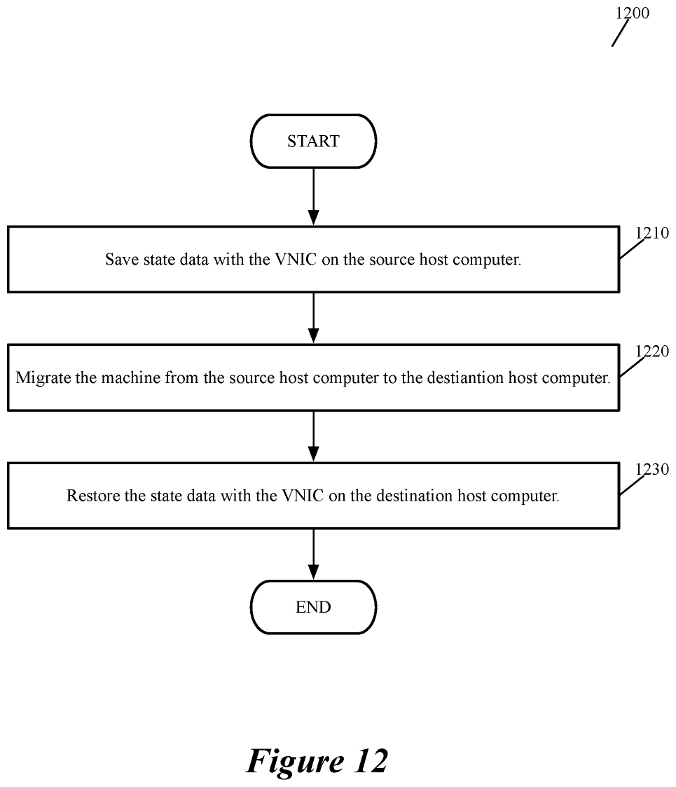

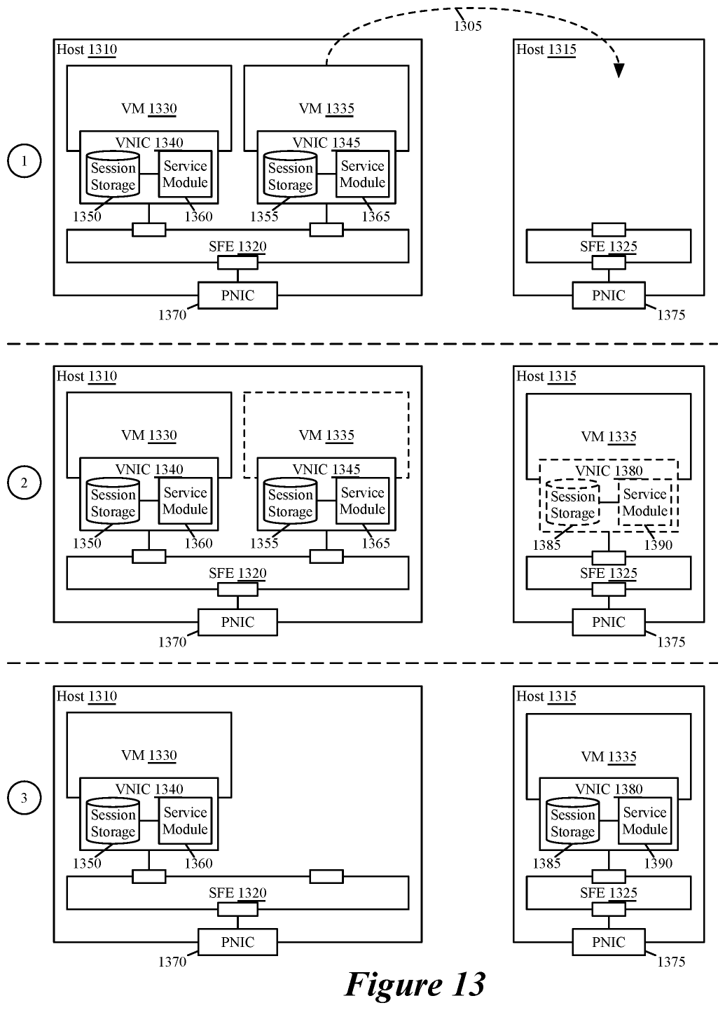

As mentioned above, the SVM 120 in some embodiments offloads one or more services to the VNIC 130. The offloaded services, in some embodiments, are stateful services, such as middlebox services that include firewall services, load balancing services, IPsec (Internet protocol security) services (e.g., authentication and encryption services), and encapsulation and decapsulation services. When the SVM offloads one or more services to the VNIC, in some embodiments, the SVM initially owns state data for data messages serviced by the VNIC, while the VNIC itself maintains copies of the state data when the offloading is initialized or reconfigured. In some embodiments, if the machine is migrated from the host computer to another host computer, the state data is saved with the VNIC on the source host computer, and subsequently restored on a VNIC executing on the destination host computer, which can continue performing stateful services that were previously offloaded to the VNIC executing on the source host computer. Restoration of state data when an SVM is migrated will be described in further detail by FIGS. 12-13 below.

On the host computer 100, services are performed on data messages sent to and from the SVM 120 by a service application 125. When the services are offloaded to the VNIC 130, a VNIC stateful service module 135 performs the offloaded services according to configuration data and service rules provided to the VNIC 130 by the SVM 120. For instance, in some embodiments, services may be offloaded to the VNIC 130 following a determination that virtual resources allocated to the SVM 120 may be over-utilized by the service application 125, and as a result, the SVM 120 provides security session configuration data and state data associated with one or more flows, as well as service rules to apply to the one or more flows, to the VNIC 130 for use by the VNIC stateful service module 135. For example, the offloaded services of some embodiments can include connection tracking services. The VNIC stateful service module 135 then uses resources of the host computer 100 (i.e., rather than virtual resources allocated to the SVM 120) to perform services on data messages, thereby freeing up virtual resources allocated to the SVM 120.

In some embodiments, smartNICs can also be utilized for offloading and accelerating a range of networking data path functions from the host CPU. These smartNICs also offer more programmable network processing features and intelligence compared to a traditional NIC, according to some embodiments. Some common data path functions supported by smartNIC include multiple match-action processing, tunnel termination and origination, etc. The match-action table works very similarly with flow cache and can be offloaded with relatively small efforts, in some embodiments. For example, the PNIC 140 is a smartNIC and includes a smartNIC stateful service module 145 for performing services on data messages. In some embodiments, each of the service application 125, VNIC stateful service module 135, and smartNIC stateful service module 145 perform services for different sets of data message flows to and from the SVM 120. Additional details regarding offloading services from a VM to the VNIC, and further from the VNIC to the PNIC, will be further described below.

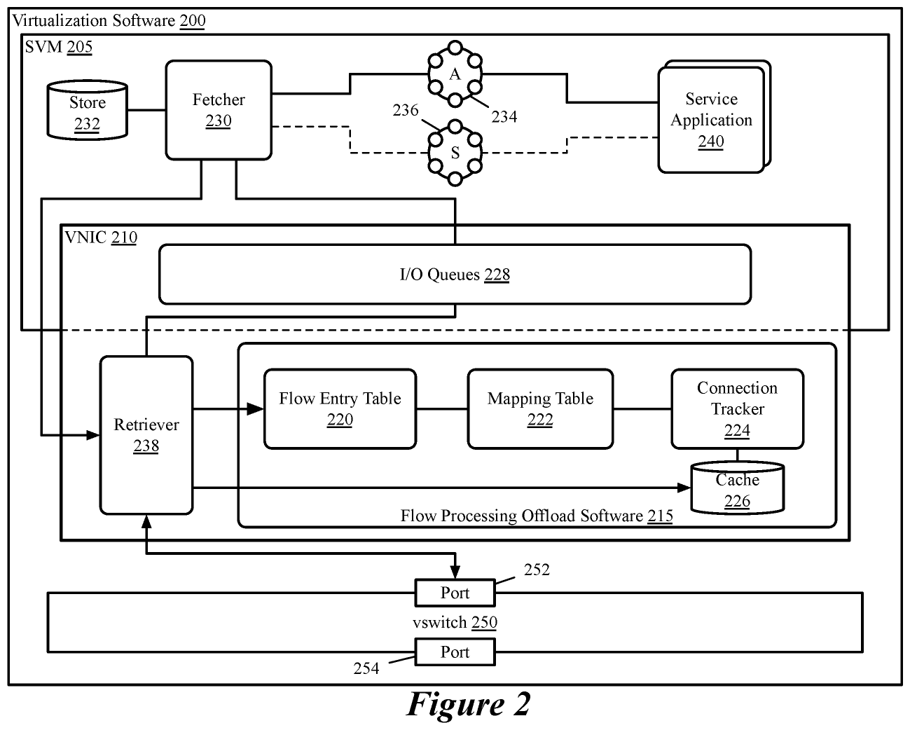

FIG. 2 illustrates virtualization software of some embodiments that includes a virtual switch, a virtual machine (VM), and a VNIC that includes components for performing services offloaded from the VM. As shown, the virtualization software 200 includes a virtual switch 250, a service VM (SVM) 205, and a VNIC 210. The VNIC 210 includes a retriever 238, flow processing offload software 215, and I/O queues 228, while the SVM 205 includes service applications 240, a pair of active/standby storage rings 234 and 236, a data fetcher 230, and a datastore 232.

The port 252 of the virtual switch 250 enables the transfer of data messages between the virtual switch 250 and the SVM 205. For instance, data messages of some embodiments are sent from port 252 to I/O queues 228 of the VNIC 210. The number N of I/O queues 228 varies in different embodiments. Data messages are sent from the port 252 to the I/O queues 228 using the retriever 238. In some embodiments, the retriever 238 is one of multiple retrievers and the data fetcher 230 is one of multiple data fetchers. The number N of retrievers 238, in some embodiments, is the same number N of I/O queues 228 as each queue is associated with a different retriever, and the number N of I/O queues is equal to the number N of data fetchers 230. In some embodiments, each queue in the I/O queues 228 is associated with its own retriever 238, data fetcher 230, datastore 232, and active/standby ring pair 234 and 236. Other embodiments, however, may have a single retriever associated with all ports of a switch and all queues of a VNIC, as well as a single data fetcher and associated datastore.

A storage ring, in some embodiments, is a circular buffer of storage elements that stores values on a first in, first out basis, with the first storage element being used again after the last storage element is used to store a value. The storage elements of a storage ring are locations in a memory (e.g., a volatile memory or a non-volatile memory of storage). Both the VNIC's I/O queues 228 and the storage rings 234 and 236 are used as holding areas for data messages so processes that need to process these data messages can handle large amounts of traffic. Using an active/standby configuration of storage rings provides for a high throughput ingress datapath for data messages. In some embodiments, each storage ring 234 and 236 is the same size. For instance, the storage rings 234 and 236 are illustrated as each having six storage elements. Storage rings are also referred to as rings, ring buffers, and circular buffers in the discussions below.

The data fetcher 230 identifies which ring is active and which ring is standby using the datastore 232. In some embodiments, a monitoring engine (not shown) executes on the SVM 205 and updates the datastore 232 with active/standby designations for the rings 234 and 236, while in other embodiments, the monitoring engine (not shown) provides this information (i.e., provides data identifying the active and standby designations) to the data fetcher 230 through a function call, and the data fetcher 230 then stores the information in the datastore 232. The data in the datastore 232 is also used by processes in the service applications 240, according to some embodiments.

In some embodiments, the service applications 240 include a set of processes (not shown) for retrieving data messages from the rings 234 and 236. In other embodiments, the set of processes can be part of the operating system (OS) and handoff data messages to the service applications 240 for processing. In some embodiments, like the data fetcher 230, the set of processes for the service applications 240 includes one process for each ring pair 234-236. In other embodiments, multiple processes retrieve data messages from a particular ring pair 234-236 associated with a particular I/O queue 228. Usually, the set of processes for the service applications 240 retrieves data messages from the active ring 234 in the ring pair, but may also retrieve data messages from the standby ring 236 in the ring pair, as denoted by a dashed line. In some embodiments, after a switch of the active/standby designation of the ring pair 234-236 (i.e., the active ring becomes the new standby ring and the standby ring becomes the new active ring), the set of processes for the service applications 240 continues to retrieve data messages from the new standby ring until that ring is completely empty. In some embodiments, only once the new standby ring is completely empty are data messages retrieved from the new active ring.

The service applications 240, in some embodiments, perform stateless and stateful services on data messages sent to and from the SVM 205. For instance, in some embodiments, the service applications 240 perform one or more operations on data messages, such as firewall operations, middlebox service operations, etc. In some embodiments, after the first few data messages of a data message flow have been processed by the service applications 240, processing for the subsequent N number of data messages is offloaded to the VNIC 210. The SVM 205 of some embodiments offloads the services to the VNIC 210 in order to preserve virtual resources allocated to the SVM 205, and the VNIC 210 uses resources of the host computer (not shown) to perform the services. The processing that is offloaded to the VNIC 210, in some embodiments, includes matching a data message's five-tuple identifier and using the match to identify a corresponding action (e.g., allow or drop), as well as checking the state (e.g., sequence number, acknowledgement number, and other raw data).

In some embodiments, in addition to its role in fetching data messages from the I/O queues 228 and adding the data messages to the storage rings 234-236, the data fetcher 230 is also a VNIC driver that manages and configures the VNIC 210. In order to offload data message processing from the SVM 205 to the VNIC 210, the data fetcher 230 of some embodiments provides configuration data to the retriever 238 for configuring components of the flow processing offload software to take over the processing of data messages belonging to one or more flows from the SVM 205. Upon receiving the configuration data from the data fetcher 230 (i.e., the VNIC driver), the retriever 238 stores the configuration data in the cache 226 for use by the connection tracker 224. The configuration data, in some embodiments, includes security session configuration data and state data associated with one or more flows.

The offloaded processing is performed by components of the flow processing offload software 215. As shown, the flow processing offload software 215 includes a flow entry table 220, a mapping table 222, a connection tracker 224, and a cache 226. In some embodiments, the flow entries and the mappings are stored in network processing hardware for use in performing flow processing for the SVM 205. The flow entries and mapping tables, in some embodiments, are stored in separate memory caches (e.g., content-addressable memory (CAM), ternary CAM (TCAM), etc.) to perform fast lookup.

To perform the offloaded processing, in some embodiments, the retriever 238 provides data messages to the flow entry table 220 within the flow processing offload software 215. The data messages' 5-tuple headers are matched against flow entries in the flow entry table 220. Each flow entry, in some embodiments, is for a particular data message flow and is generated based on a first data message received in the data message flow (e.g., received by the SVM 205 before processing is offloaded to the VNIC 210). The flow entry is generated, in some embodiments, based on the result of data message processing performed by the SVM 205 (or its service applications 240).

For each flow entry in the flow entry table 220, in some embodiments, the mapping table 222 includes an action associated with a data message that matches that flow entry. As such, once a data message has been matched to a flow entry in the flow entry table 220, the data message is passed to the mapping table 222 to identify a corresponding action to be performed on the data message. The actions, in some embodiments, include: a forwarding operation (FWD), a DROP for packets that are not to be forwarded, modifying the packet's header and a set of modified headers, replicating the packet (along with a set of associated destinations), a decapsulation (DECAP) for encapsulated packets that require decapsulation before forwarding towards their destination, and an encapsulation (ENCAP) for packets that require encapsulation before forwarding towards their destination. In some embodiments, some actions specify a series of actions. For instance, in some embodiments, the series of actions can include allowing data messages matching a particular flow entry, modifying headers of the data messages, encapsulating or decapsulating the data messages, and forwarding the data messages to their destinations. As mentioned above, the VNIC 210 uses resources of the host computer (not shown) to perform the actions on data messages, which in turn frees up virtual resources on the SVM 205.

In some embodiments, before the matched actions are performed on a data message, the data message is passed to the connection tracker 224, which performs a lookup in the cache 226 to determine whether a record associated with the data message's flow indicates the connection is still valid. The record, in some embodiments, includes a flow identifier and a middlebox service operation parameter. The flow identifier in the record, in some embodiments, includes layer 4 (L4) and/or layer 7 (L7) parameters, such as sequence number, acknowledgement number, and/or other parameters that can be garnered from the data message's raw data and matched against the associated record in the cache 226. In some embodiments, the middlebox service operation parameter can include, for example, “allow/deny” for firewall operations, or virtual IP (VIP) to destination IP (DIP) mapping for load balancing operations. The middlebox service operation parameter is produced by the SVM (or a service engine, as will be further described below) based on the operation(s) performed by the SVM (or service engine) for a first packet or first set of packets belonging to the data message flow, and used along with the flow identifier to create the record for use by the connection tracker 224.

In some embodiments, for data messages associated with connections determined to still be valid, the matched actions are performed using resources of the host computer (not shown), as well as any other actions specified by the cache record. For example, in some embodiments, the cache record specifies an action of “to destination” or “to VM”, depending on the destination associated with the data message, and the data message is then forwarded to the SVM 205 or a destination. Additionally, the cached record is updated (e.g., connection tracking state) based on the processed data message. For timed-out connections, the data messages are instead forwarded to the SVM 205 for processing (e.g. by the service applications 240).

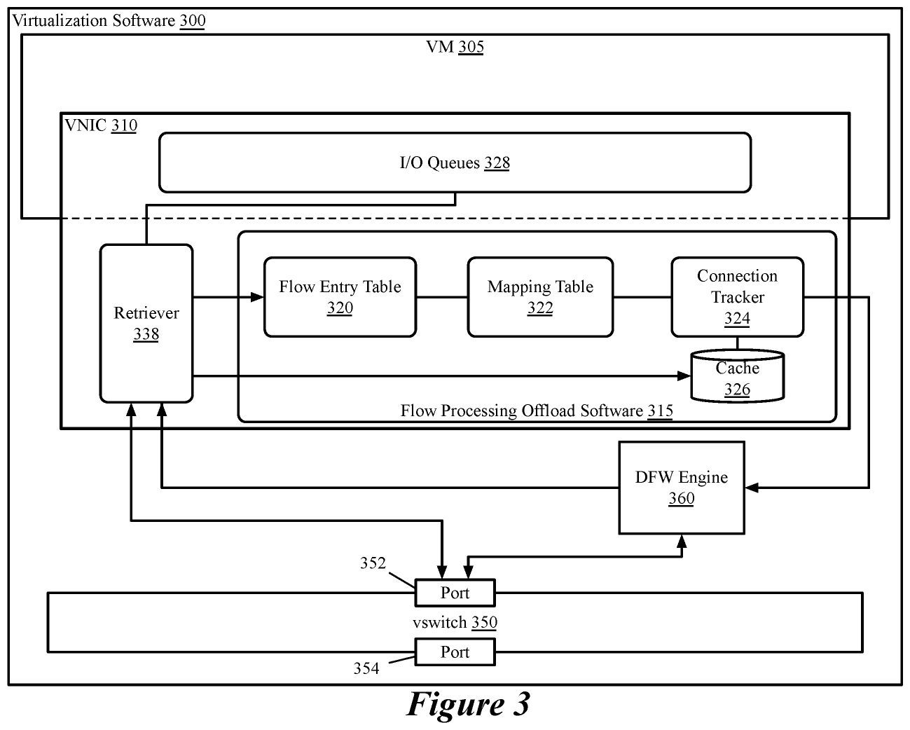

In some embodiments, the virtualization software executes machines other than SVMs (e.g., other VMs that are end machines), and, in some such embodiments, firewall operations and other middlebox service operations are performed by a distributed firewall (DFW) engine and middlebox service engines executing on the virtualization software and outside of the SVM. FIG. 3 illustrates virtualization software of some embodiments that includes a virtual switch 350, a VM 305, a DFW engine 360, and a VNIC 310 that includes components for performing services offloaded from the VM. Like the VNIC 210, the VNIC 310 includes I/O queues 328, a retriever 338, and flow processing offload software 315. Unlike the embodiment described above for FIG. 2, which includes the SVM 205 the VM 305 is an end machine that is either a source or destination of the data message flow, according to some embodiments.

While illustrated as a single component, the DFW engine 360, in some embodiments, is a set of service engines that includes a DFW engine as well as other middlebox service engines for performing services on data messages to and from the VM 305. In some embodiments, stateful services are offloaded from the DFW engine, or other middlebox service engines, to the VNIC to enable faster processing. That is, when the stateful services can be performed by the VNIC instead of the service engines, the VNIC can quickly process a data message without having to call any of the service engines.

In order to offload data message processing services to the VNIC 310, the DFW engine 360 of some embodiments provides configuration data to the retriever 338. The retriever 338 then stores the configuration data (e.g., security session configuration data, state data, etc.), in the cache 326 for use by the connection tracker 324. In some embodiments, the retriever 338 also configures the connection tracker 324 to perform operations on the data messages processed by the VNIC 310. The services offloaded to the VNIC 310, in some embodiments, include stateful services for all data messages, while in other embodiments, only specific data message flows are to be processed by the VNIC.

When inbound data messages belonging to flows to be processed by the VNIC arrive at the port 352, the retriever 338 retrieves these data messages and provides them to the flow entry table 320. The flow entry table 320 includes flow entries corresponding to data message flows being processed by the VNIC 310, in some embodiments. When a match is identified (e.g., a 5-tuple of the data message matches a 5-tuple flow entry), the data message is passed to the mapping table 322 to identify a corresponding action or actions to be performed on the data message. As mentioned above, such actions, in some embodiments, can include a forwarding operation (FWD), a DROP for packets that are not to be forwarded, modifying the packet's header and a set of modified headers, replicating the packet (along with a set of associated destinations), a decapsulation (DECAP) for encapsulated packets that require decapsulation before forwarding towards their destination, and an encapsulation (ENCAP) for packets that require encapsulation before forwarding towards their destination.

The connection tracker 324 then performs a lookup in the cache 326 to determine whether a record associated with the data message flow is still valid (e.g., has not yet timed-out). In some embodiments, when the connection tracker 324 determines that the record is no longer valid, the data message is provided to the DFW engine 360 for processing. Otherwise, the connection tracker 324 performs any actions specified by the valid record, and the data message is forwarded to its destination. In some embodiments, the action specified by the record is a forwarding operation of “to VM” or “to destination”, depending on whether the destination of the data message is the VM 305 or a destination other than the VM 305. When the destination of the data message is the VM 305, the data message is provided back to the retriever 338, which adds the data message to the I/O queues 328 for retrieval by one or more components of the VM 305 (e.g., the data fetcher 230 described above for FIG. 2).

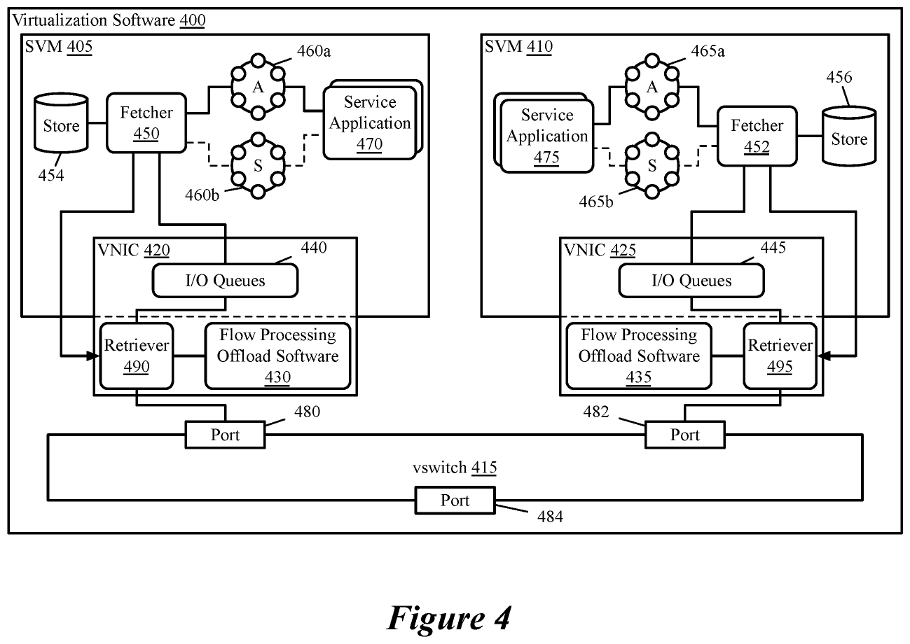

In some embodiments, multiple VMs or SVMs execute within virtualization software on the same host computer, with each VM or SVM having a respective VNIC to which services of some embodiments are offloaded. FIG. 4 illustrates an example of virtualization software that executes multiple SVMs each having a respective VNIC to which services can be offloaded, in some embodiments. As illustrated, the virtualization software 400 includes a virtual switch 415 that includes a port 484 for sending data messages to and from elements external to the virtualization software 400, as well as separate ports 480 and 482 to which respective VNICs 420 and 425 of respective SVMs 405 and 410 attach. Each VNIC 420 and 425 includes a respective retriever 490 and 495, flow processing offload software 430 and 435, and I/O queues 440 and 445. Additionally, each SVM 405 and 410 includes a respective data fetcher 450 and 452, datastore 454 and 456, active/standby storage ring pair 460a-460b and 465a-465b, and service applications 470 and 475.

In some embodiments, SVM 405 may determine that processing for one or more data message flows should be offloaded to the VNIC 420, while the SVM 410 continues to have all data message processing performed by, e.g., the service applications 475. In some such embodiments, the data fetcher 450 provides configuration data to the retriever 490, which stores the configuration data in the cache (not shown) that is included in the flow processing offload software 430. The retriever 490 then retrieves data messages sent to SVM 405 from the port 480, and provides the data messages to the flow processing offload software 430 for processing, while the retriever 495 continues to retrieve data messages sent to the SVM 410 from the port 482 and adds these data messages to the I/O queues 445 for retrieval by the data fetcher 452 for processing by the SVM 410 (i.e., by the service applications 475). As such, data messages belonging to one or more flows to and from the SVM 405 are processed by the VNIC 420 using resources of the host computer (not shown), while data messages belonging to one or more flows to and from the SVM 410 are processed by the SVM 410 using virtual resources allocated to the SVM 410, according to some embodiments.

For embodiments such as FIG. 3 where the services are not performed by the machine, but rather by one or more engines, such as DFW engine 360 executing in the virtualization software 300, services for some VMs may be performed by the DFW engine 360, while services for other VMs may be performed by their corresponding VNICs, according to some embodiments. In some embodiments, the DFW engine 360 may perform services for certain flows to and from each VM, while the VNICs corresponding to each VM perform services for flows other than those serviced by the DFW engine 360.

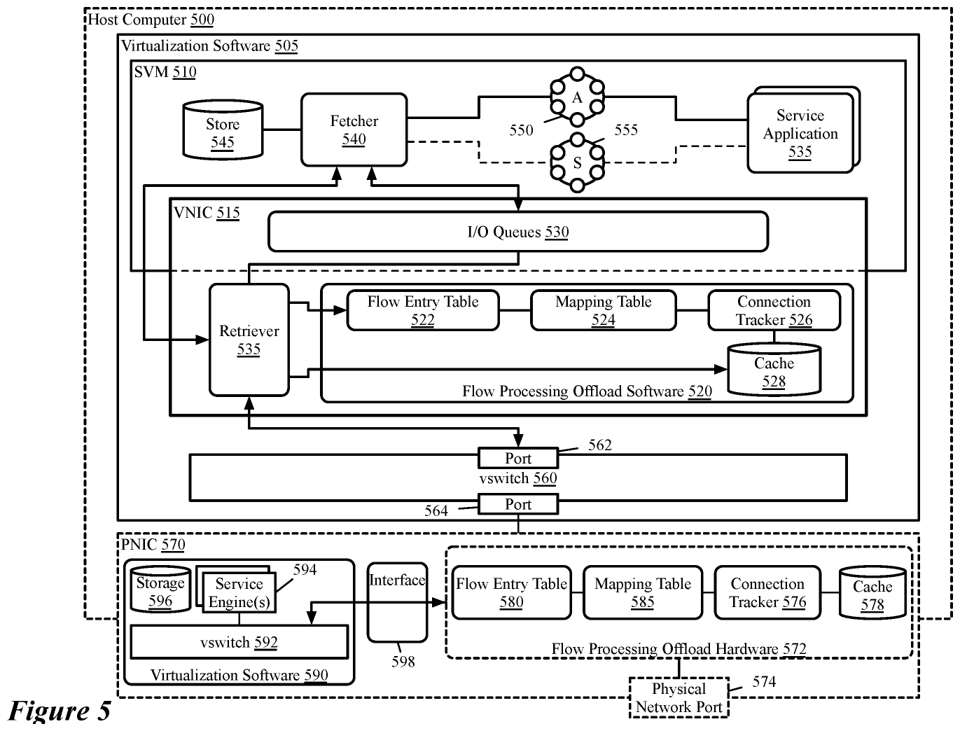

In some embodiments, services can be further offloaded to the PNIC when such services are supported. FIG. 5 illustrates a host computer 500 that includes a PNIC 570 and virtualization software 505. The virtualization software 505 includes an SVM 510, VNIC 515, and virtual switch 560 having two ports 562 and 564. The PNIC 570 includes flow processing offload hardware 572, a physical network port 574, an interface 598, and virtualization software 590. In this example, hardware components are illustrated with a dashed line, while software components are illustrated with a solid line.

Like the SVM 205 and VNIC 210, the SVM 510 also includes service applications 535, a pair of active/standby storage rings 550 and 555, a data fetcher 540, and a datastore 545, while the VNIC 515 includes a retriever 535, flow processing offload software 520, and I/O queues 530. When services (i.e., connection tracking services) are offloaded from the SVM 510 to the VNIC 515, the offloading is performed in the same manner as described above for FIG. 2, with the fetcher 540 providing configuration data to the receiver 535, which stores the configuration data in the cache 528 for use by the connection tracker 526. As data messages are provided by the retriever 535, the flow entry table 522 and subsequently the mapping table 524 perform look-ups to determine whether the data message is to be processed by the VNIC 515 and, if so, which actions are to be performed on the data message.

In some embodiments, such as with the host computer 500, the PNIC may support further offloading of services. As mentioned above, the PNIC 570 includes flow processing offload hardware 572, a physical port 574, an interface 598, and virtualization software 590. Like the flow processing offload software 520 of the VNIC 515, the flow processing offload hardware 572 of the PNIC 570 includes a flow entry table 580, a mapping table 585, a connection tracker 556, and a cache 578. The virtualization software 590 of the PNIC 570 includes a virtual switch 592, service engine(s) 594, and storage 596. In some embodiments, the virtualization software 590 is a manufacturer virtualization software for providing single root I/O virtualization (SR-IOV) that enables efficient sharing of resources of a PCIe-connected device among compute nodes. In other embodiments, the virtualization software 590 is a hypervisor program (e.g., ESX™ or ESXi™ that is specifically designed for virtualizing resources of a smart NIC). The virtualization software 590 and the virtualization software 505 can be managed separately or as a single logical instance, according to some embodiments.

In some embodiments, when the VNIC 515 offloads services (e.g., connection tracking services) for a flow to the PNIC 570, the retriever 535 provides the configuration data stored in the cache 528 for the flow to the PNIC 570. The virtual switch 592 that executes in the virtualization software 590 of the PNIC 570 then uses the configuration data to populate the flow entry table 580 and mapping table 585, and stores the state data for the flow in the cache 578. As shown, the virtual switch 592 communicates with the flow processing offload hardware 572 via the interface 598 between the virtualization software 590 and the flow processing offload hardware 572. The interface 598, in some embodiments, is a peripheral component interconnect express (PCIe).

Once the configuration data has been provided to the PNIC 570, the PNIC 570 can then use the flow processing offload hardware 572 to process one or more data message flows based on the configuration data. Using the elephant flow example mentioned above, for data message inbound to the SVM 510, the physical network port 574 receives the data messages and provides them to the flow processing offload hardware 572. The flow entry table 580 then performs a lookup to match a 5-tuple of the data message to a flow entry, and the mapping table 585 is then used to identify one or more actions to perform on the data message, according to some embodiments. Like the connection tracker 526, the connection tracker 576 also uses data extracted from data messages to perform look-ups in the cache 578 to identify records associated with data message flows, determine whether the data message flow's state is still valid, and, when applicable, update the records based on the current data message being processed (e.g., update state information for the flow). Once the data message has been processed, it is forwarded to the port 564 of the virtual switch 560 for delivery to the SVM 510.

In some embodiments, the data message is provided to the virtualization software 590 for additional processing by the service engines 594. These service engines 594, in some embodiments, perform logical forwarding operations on the data message, in some embodiments, as well as other operations (e.g., firewall, middlebox services, etc.). Once the data message's processing is completed, the data message is forwarded to the port 564 (e.g., via the virtual switch 592) for delivery to a component on the host computer 500.

For outbound data messages, the flow processing offload hardware 572 instead receives the data message from the virtual switch 592 after the virtual switch 592 receives the data messages from the port 564. The flow processing offload hardware 572 then processes the data message, and provides the data message to the physical network port 574 for forwarding to its destination external to the host computer 500. In some embodiments, processing of data messages sent between components of the host computer 500 is offloaded to the VNIC 515, while processing of data messages between a component of the host computer 500 and a destination external to the host computer 500 is offloaded to the PNIC 570.

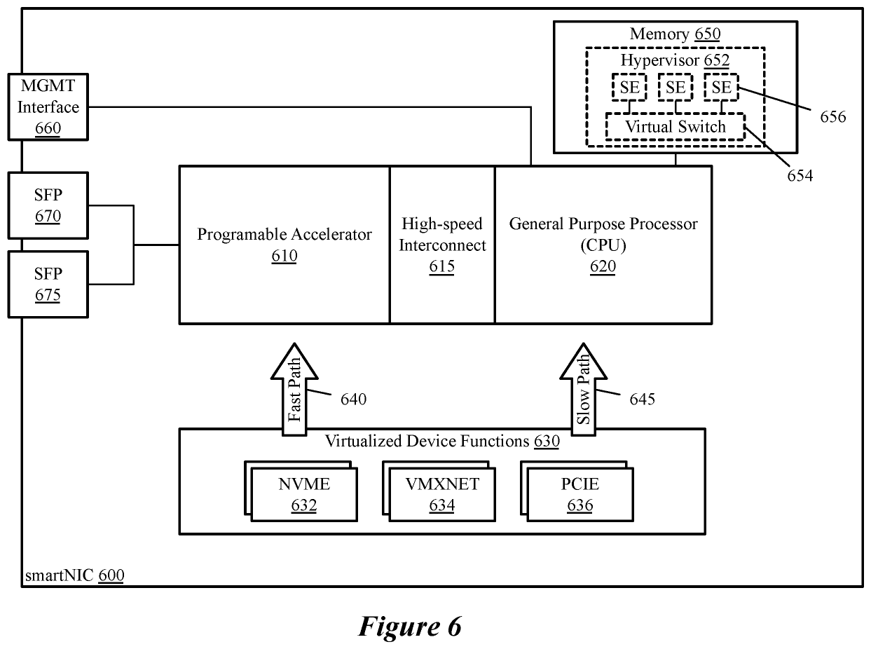

FIG. 6 conceptually illustrates an example embodiment of a smartNIC. As shown, the smartNIC 600 includes a programmable accelerator 610, high-speed interconnect 615, general purpose processor 620, virtualized device functions 630, fast path offload 640, slow path processor 645, memory 650, out-of-band management interface 660, and small form-factor pluggable transceivers (SFPs) 670 and 675.

The programmable accelerator 610, in some embodiments, is a field programmable gate array (FPGA) device that includes embedded logic elements for offloading CPU (central processing units). In some embodiments, FPGA devices enable high performance while also having low latency, low power consumption, and high throughput. The high-speed interconnect 615 provides an interconnect between the programmable accelerator 610 and the general purpose processor 615. The general purpose processor 615, in some embodiments, enables applications to run directly on the smartNIC. These applications, in some embodiments, provide networking and storage services, and can improve performance and save CPU. Additionally, the general purpose processor 615 is managed independently from the CPU of the host computer on which it executes (e.g., via the interface 660).

The smartNIC 600 also includes virtualized device functions 630 that appear to the core CPU operating system (OS) and applications as if they are actual hardware devices. As shown, the virtualized device functions 630 include NVME (nonvolatile memory express) 632 that provides storage access and transport protocol for high-throughput solid-state drivers (SSDs), VMXNET 634 that is a high-performance virtual network adapter device for VMs, and PCIe 636 that is a high-speed bus. The fast path offload 640 processes data messages based on stored flow entries. The slow path processor 645 performs slow path processing for data messages that are not associated with an existing flow entry based on network configuration and characteristics of a received data message.

The memory 650 of some embodiments includes the hypervisor 652, which executes a virtual switch 654 and service engines 656. That is, the memory 650 of the smartNIC 600 includes programming for the hypervisor 652. In some embodiments, the virtualized device functions 630 are executed by the hypervisor 652, and the virtual switch 654 includes the fast path offload 640 and slow path processor 645. In some embodiments, the virtualized device functions 630 includes a mix of physical functions (PFs) and virtual functions (VFs), and each PF and VF refers to a port exposed by the pNIC using a PCIe interface. A PF refers to an interface of the pNIC that is recognized as a unique resource with a separately configurable PCIe interface (e.g., separate from other PFs on a same pNIC). The VF refers to a virtualized interface that is not separately configurable and is not recognized as a unique PCIe resource. VFs are provided, in some embodiments, to provide a passthrough mechanism that allows compute nodes executing on a host computer to receive data messages from the pNIC without traversing a virtual switch of the host computer. The VFs, in some embodiments, are provided by virtualization software executing on the pNIC.

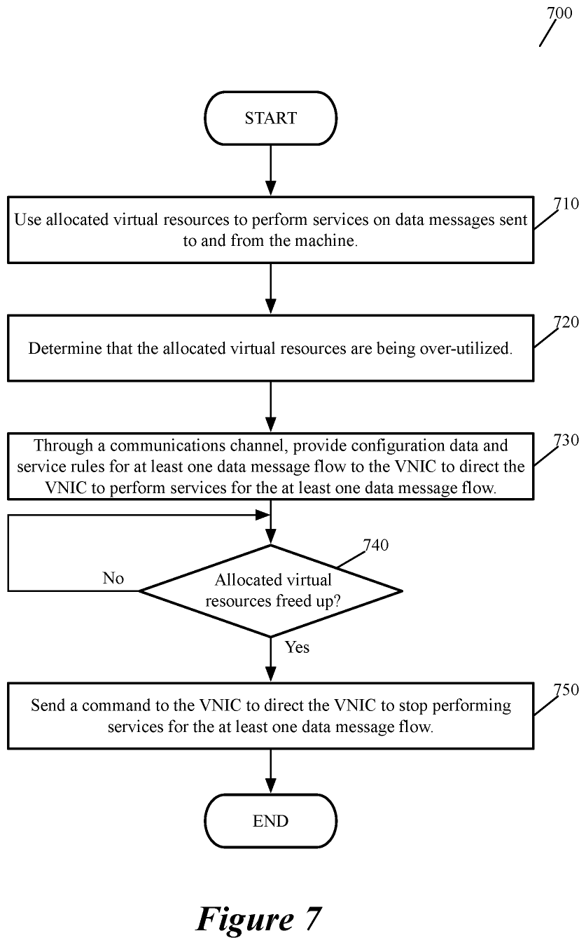

FIG. 7 conceptually illustrates a process performed by a machine in some embodiments to offload one or more services to a VNIC. The process 700 is performed in some embodiments by a machine executing on a host machine. The process 700 will be described with reference to FIGS. 2-4. The process 700 starts when the machine uses (at 710) allocated virtual resources to perform services on data messages sent to and from the machine. For instance, the service applications 240 executing on the SVM 205 use virtual resources allocated to the SVM 205 to perform services for data messages sent to and from the SVM 205, according to some embodiments. In some embodiments, such as in FIG. 4, the multiple SVMs 405 and 410 executing on the same host computer (not shown) perform services using virtual resources allocated to a shared pool for all of the SVMs on the same host, while in other embodiments, each SVM is allocated a respective amount of virtual resources.

The process 700 determines (at 720) that the allocated virtual resources are being over-utilized. The machine, in some embodiments, determines that its allocated set of virtual resources is being over-utilized upon determining that a particular quality of service (QoS) metric (e.g., latency, throughput, etc.) has exceeded or has failed to meet a specified threshold. In some embodiments, the QoS metric may be associated with a particular data message flow for which there is a specified service guarantee.

For instance, in some embodiments, when a machine (e.g., SVM 205) is unable to meet a specified threshold for, e.g., throughput, the machine begins to direct the VNIC to perform one or more services on one or more data message flows that are associated with the machine and that are categorized at a certain priority level (e.g., all data message flows having a low priority or all data message flows having a high priority, etc.), while the machine continues to perform the one or more services for all other data message flows. These services in some embodiments include forwarding operations (FWD), DROP for packets that are not to be forwarded, modifying the data message's header and a set of modified headers, replicating the data message (along with a set of associated destinations), a decapsulation (DECAP) for encapsulated data messages that require decapsulation before forwarding towards their destination, and an encapsulation (ENCAP) for data messages that require encapsulation before forwarding toward their destination.

Through a communications channel between the machine and the VNIC, the process provides (at 730) configuration data and service rules for at least one data message flow to the VNIC to direct the VNIC to perform services for the at least one data message flow. That is, the machine offloads services for one or more data message flows to the VNIC, which utilizes resources (e.g., CPU) of the host computer to perform the services, thereby freeing up the virtual resources allocated to the machine for performing other functions. In some embodiments, the machine offloads services for data message flows having a certain priority level (e.g., all low priority flows, all high priority flows, etc.) to the VNIC while continuing to perform services for all other flows to and from the machine. As described above for FIG. 2, the data fetcher 230 of some embodiments provides the configuration data to the retriever 238, which adds the configuration data to the cache 226 for use by the connection tracker 224 of the flow processing offload software 215. The data fetcher 230, in some embodiments, is a VNIC driver, while the retriever 238, of some embodiments, serves as a VNIC backend.

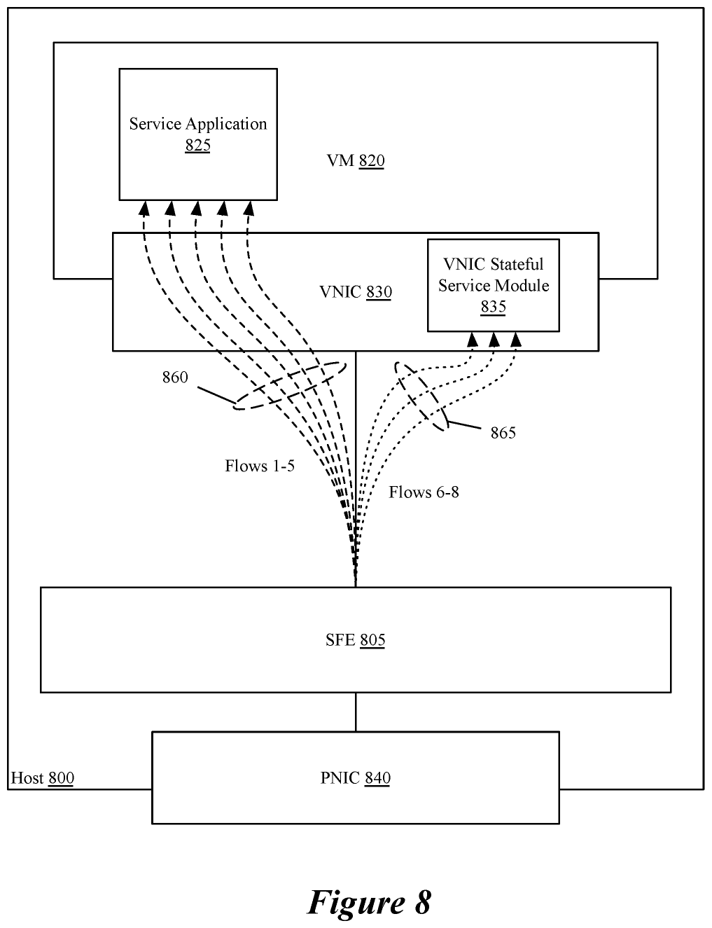

In another example, FIG. 8 conceptually illustrates different data message flows being directed to either a VM or VNIC executing on a host computer, according to some embodiments. As shown, the host computer 800 includes a PNIC 840, an SFE 805, a VM 820, and a VNIC 830. The VM 820 includes a service application 825 for providing one or more services to data message flows sent to and from the VM 820, while the VNIC 830 includes a VNIC stateful service module 835 (i.e., flow processing offload software) for performing one or more offloaded services for one or more data message flows sent to and from the VM 820.

In this example, a first set of five flows 860 are directed through the VNIC 830 and to the service application 825, while a second set of three flows 865 are directed to the VNIC stateful service module 835 of the VNIC 830. In some embodiments, the flows 860 are all low priority flows, while the flows 865 are high priority flows (or vice versa), while in other embodiments, other attributes are used to assign flows to the VNIC. In still other embodiments, the VM 820 directs the VNIC 830 to perform a specific set of services for all flows, while the VM 820 performs additional services for the flows.

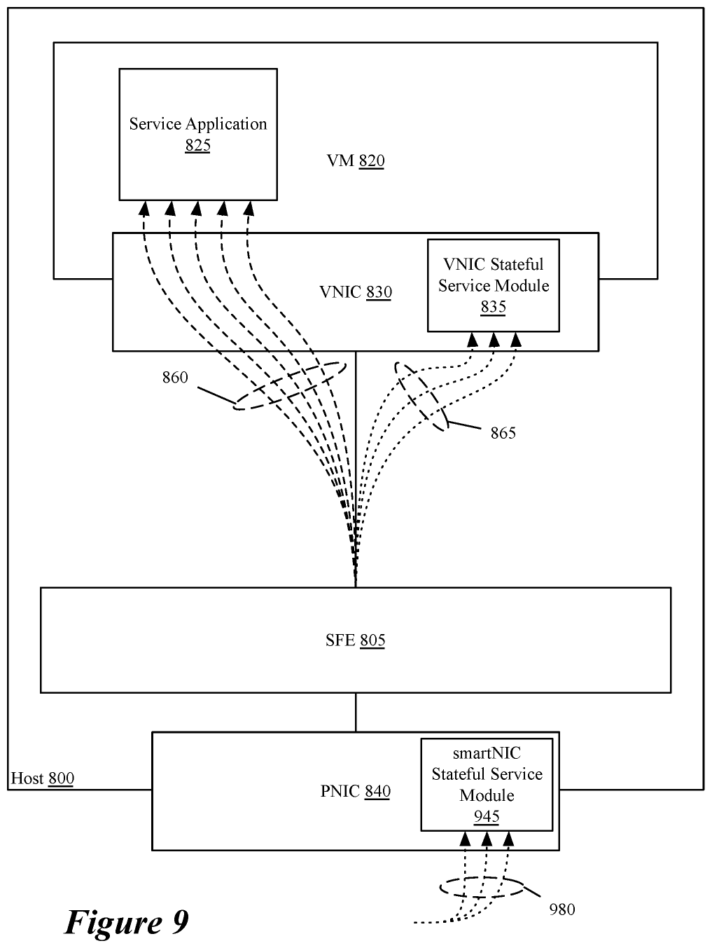

In some embodiments, as described above, one or more services and/or services for one or more flows may also be offloaded to the PNIC. FIG. 9 conceptually illustrates an example in which different inbound flows are processed by the PNIC, VNIC, and VM, according to some embodiments. As shown, the PNIC 840 on the host computer 800 now also includes the smartNIC stateful service module 945. While the inbound flows 860 are still directed to the service application 825 for services, and the inbound flows 865 are still directed to the VNIC stateful service module 835, an additional group of inbound flows 970 are directed to the smartNIC stateful service module 945. That is, because of the configuration data provided to the PNIC (e.g., as described above for FIG. 5), as data messages reach the PNIC 840 from external sources, the PNIC of some embodiments uses the configuration data to determine whether the data messages are to be processed at the PNIC by the smartNIC stateful service module 945, or whether the data messages should be passed to the SFE 805 for delivery to the VM 820 via the VNIC 830. In other embodiments, the PNIC 840 may provide all inbound data messages to the smartNIC stateful service module 945 for stateful service operations based on the configuration data.

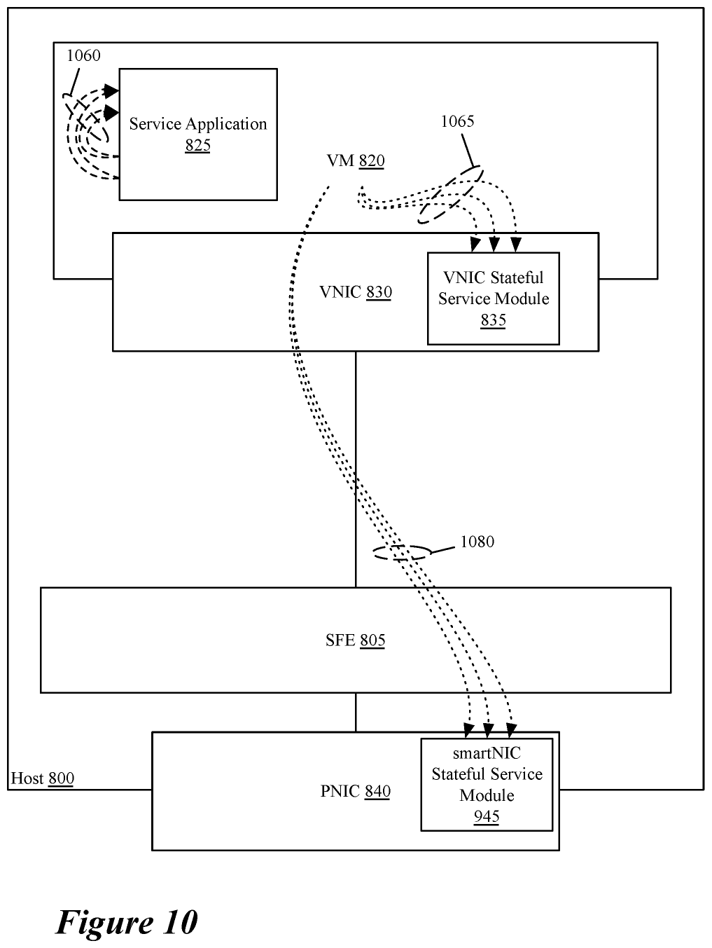

In addition to inbound flows, services for data messages sent from the VM 820 can also be offloaded to the VNIC 830 and/or PNIC 840, according to some embodiments. For example, FIG. 10 conceptually illustrates an example in which various outbound flows are serviced by the VM, VNIC, and PNIC, in some embodiments. As shown, the service application 825 on the VM 820 performs one or more services for a first set of flows 1060, while the VNIC stateful service module 835 on the VNIC 830 performs one or more services for a second set of flows 1065, and the smartNIC stateful service module 945 on the PNIC 840 performs one or more services on a third set of flows 1070 before forwarding the data messages to their destinations. In some embodiments, the VM 820 is one of multiple machines executing on the host 800, and the VM 820 directs the VNIC 830 to perform services for data message flows destined to or received from other such machines executing on the host 800, and the PNIC 840 to perform services for data message flows destined to or received from machines external to the host computer 800. Additionally, in some embodiments, the services are offloaded from a component of the virtualization software executing on the host computer to one or more VNICs of one or more machines also executing in the virtualization software, as described above with reference to FIG. 3.

Returning to the process 700, the process determines (at 740) whether the allocated virtual resources have freed up. For instance, a machine may experience an influx of data message flows during a particular period of time, and once that period of time has expired, the machine subsequently receives a manageable amount of data message traffic. In another example, the machine can detect an elephant flow, and offload processing of a number N data messages belonging to the elephant flow to the VNIC, and once the VNIC has processed the number N data messages, processing of that flow returns to the machine. In some embodiments, in addition to, or instead of determining whether the allocated virtual resources have freed up, the machine determines whether the host computer's resources that are being utilized by the VNIC need to be freed up for other functions of the host computer.

When the allocated virtual resources have freed up, the process transitions to send (at 750) a command to the VNIC (i.e., through the communications channel) to direct the VNIC to stop performing services for the at least one data message flow. Like the configuration data and service rules, the command is also sent through the communications channel between the VNIC and the machine. On the host computer 800, for instance, the VM 820 may direct the VNIC 830 to cease performing services for the flows 865 such that all services for all flows 860 and 865 will subsequently be performed by the service application 825. In some embodiments, it is the data fetcher (e.g., data fetcher 230) executing on the VM (e.g., SVM 205) that directs the retriever (e.g., retriever 238) of the VNIC (e.g., VNIC 210) to stop providing data messages to the flow processing offload software of the VNIC (e.g., flow processing offload software 215). Following 750, the process 700 ends.

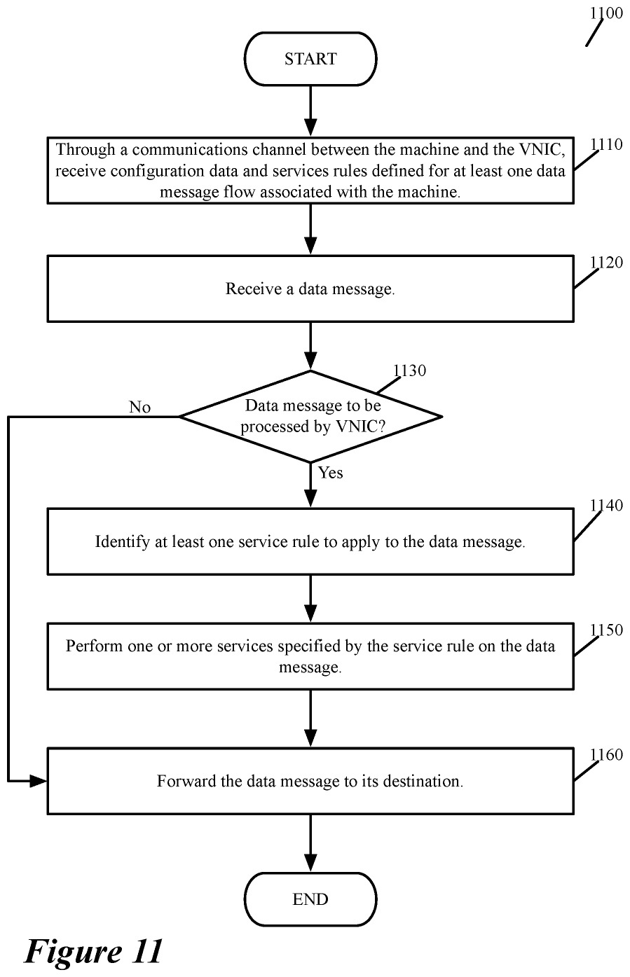

FIG. 11 conceptually illustrates a process performed by a VNIC of some embodiments that executes on a host computer and performs services on data messages sent to and from a service machine executing on the host computer. The process 1100 starts when, through a communications channel between the machine and the VNIC, the VNIC receives (at 1110) configuration data and service rules defined for at least one data message flow associated with the machine. As described above for FIG. 2, the data fetcher 230 of some embodiments provides the configuration data to the retriever 238 of the VNIC 210. The configuration data, in some embodiments, includes security session configuration data and session state data for the data message flow(s) that specifies, e.g., session identifiers for the data message flow(s), login events associated with user IDs that correspond to the data message flow(s), time stamps, service process event data, connect/disconnect event data, five-tuple information (e.g., source and destination IPs, source and destination ports, and protocol), etc.

As also described above, the SVM initially owns state data for data messages serviced by the VNIC, in some embodiments, while the VNIC itself maintains copies of the state data when the offloading is initialized or reconfigured. Additionally, if the SVM is migrated from the host computer to another host computer, the state data is saved with the VNIC on the source host computer, in some embodiments, and subsequently restored on a VNIC executing on the host computer to which the SVM is migrated, which can then continue performing the stateful services that were previously offloaded to the VNIC executing on the initial host computer, in some embodiments.

The process 1100 receives (at 1120) a data message. While SVM is not the source or destination of the data message, but rather a service machine performing service operations on the data message, the data message in some embodiments is destined to an end-machine also executing on the same host computer as the SVM. When a data message is sent to the SVM for processing, in some embodiments, the retriever 238 retrieves the data messages from the port 252 of the virtual switch 250, and provides the data messages to the flow entry table 220 within the flow processing offload software 215 of the VNIC 210, rather than to the I/O queues 228.

The process 1100 determines (at 1130) whether the data message is to be processed by the VNIC. For example, in some embodiments, the flow entry table 220 uses a 5-tuple identifier extracted from the data message's header and matches the 5-tuple against its flow entries. Additionally, the connection tracker 224 uses other flow information (e.g., L4 and L7 data) extracted from the packet and matches this other flow information against state and session data stored in the cache 226 to determine whether the data message belongs to a flow for which services (e.g., stateful connection tracking services) have been offloaded from the SVM, and for which the corresponding record is still valid (i.e., has not yet timed out). The flow information can include sequence number, acknowledgement number, and other raw data that can be garnered from the data message.

When the data message does not belong to a flow that is to be processed by the VNIC, the process 1100 transitions to forward (at 1160) the data message to the SVM. Otherwise, when the data message is determined to belong to a flow to be processed by the VNIC, the process transitions to identify (at 1140) at least one service rule to apply to the data message. In some embodiments, once a data message has matched against a flow entry in the flow entry table 220, a corresponding action or set of actions is identified in the mapping table 222. In addition to the one or more actions identified in the mapping table 222, the flow record identified by the connection tracker 224 from the cache 226, in some embodiments, also specifies an action to perform on the data message, such as “to destination” or “to VM”, to direct the data message to be forwarded to either the SVM or toward its destination, which may be a destination that is also on the same host computer as the SVM, or external to the host computer. Additionally, the record in some embodiments directs the connection tracker to update the corresponding record with data from the data message (e.g., sequence number, acknowledgment number, etc.).

Once at least one service rule has been identified, the process 1100 performs (at 1150) one or more services specified by the service rule(s) on the data message. Examples of services performed in some embodiments can include distributed firewall services (i.e., connection tracking), load balancing services, IP sec (Internet protocol security) services (e.g., authentication and encryption services), and encapsulation and decapsulation services. The connection tracker 224 also stores information regarding the state of the connection between the source and destination of the data message in the cache 226 for the data message, state, and timeout, according to some embodiments.

After the data message has been processed, the process 1100 then forwards (at 1160) the data message to its destination. In some embodiments, forwarding the data message to its destination includes forwarding the processed data message to a particular virtual port of a virtual switch associated with a destination internal to the host computer, or to a particular virtual port of the virtual switch associated with destinations external to the host computer. Following 1160, the process 1100 ends. In some embodiments, a process similar to the process 1100 is performed for offloading stateful services from a service engine (e.g., firewall engine) executing in the virtualization software on a host computer to a VNIC.

In some embodiments, when services are offloaded to the VNIC, the SVM from which the services are offloaded initially owns state data for data messages serviced by the VNIC, while the VNIC itself maintains copies of the state data when the offloading is initialized or reconfigured. The offloaded services, in some embodiments, are also supported for VMs that are migrated from one host to another. In some such embodiments, the state data associated with services provided by the VNIC is saved with the VNIC on the source host computer, and subsequently restored on a VNIC that is associated with the VM and that executes on the destination host computer. Upon restoration, the VNIC on the destination host computer can then continue performing stateful services that were previously offloaded to the VNIC executing on the source host computer.

FIG. 12 conceptually illustrates a process performed in some embodiments when migrating a machine that has offloaded services to a VNIC from one host computer (i.e., source host computer) to another host computer (i.e., destination host computer). The process 1200 will be described with references to FIG. 13, which conceptually illustrates an example of some embodiments of a VM being migrated from one host to another. The process 1200 starts by saving (at 1210) state data with the VNIC of the source host computer. In some embodiments each VNIC includes a data structure for storing data associated with providing offloaded services to data message flows, including state data associated with each flow.

At the encircled 1 in FIG. 13, for instance, the host computer 1310 includes a PNIC 1370 connected to an SFE 1320, which includes ports connecting to a first VNIC 1340 for a first VM 1330 and a second VNIC 1345 for a second VM 1335. Each of the VNICs 1340 and 1345 includes a respective session storage 1350 and 1355 (e.g., the cache 226) for storing data associated with data message flows serviced by the VNICs, as well as a respective service module 1360 and 1365 for performing the offloaded services on data messages. As indicated by the dashed arrow 1305 from the VM 1335 to the host computer 1315, which includes its own respective PNIC 1375 and SFE 1325, the VM 1335 is to be migrated from the host computer 1310 to the host computer 1315.

The process 1200 migrates (at 1220) the machine from the source host computer to the destination host computer. At the encircled 2 in FIG. 13, the VM 1335 has been migrated from the host 1310 to the host 1315, as shown. During the migration, the VNIC 1345 maintains the data associated with offloaded services provided by the VNIC until the data can be restored on the VNIC 1380 for the VM 1335 on the host 1315.

The process restores (at 1230) the state data with the VNIC on the destination host computer after the VM has been migrated. The encircled 3 in FIG. 13, for instance, shows only the VM 1330 remains on the host 1310, while the VM 1335 is now operating on the host 1315 and the state data has been restored for the VNIC 1380, which includes its own respective session storage 1385 and service module 1390 for continuing to service data messages according to the configuration data provided by the VM 1335 and stored in the session storage 1385. Following 1230, the process 1200 ends.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

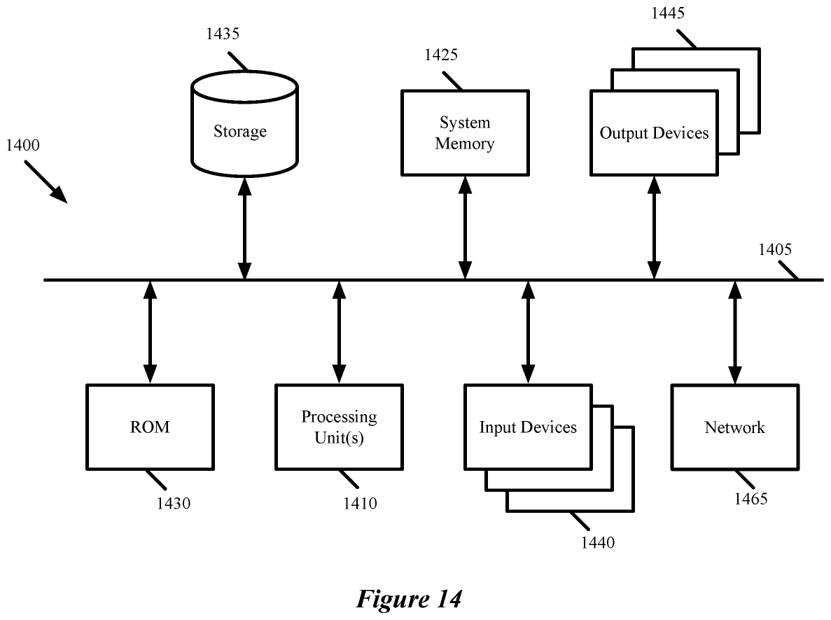

FIG. 14 conceptually illustrates a computer system 1400 with which some embodiments of the invention are implemented. The computer system 1400 can be used to implement any of the above-described hosts, controllers, gateway, and edge forwarding elements. As such, it can be used to execute any of the above described processes. This computer system 1400 includes various types of non-transitory machine-readable media and interfaces for various other types of machine-readable media. Computer system 1400 includes a bus 1405, processing unit(s) 1410, a system memory 1425, a read-only memory 1430, a permanent storage device 1435, input devices 1440, and output devices 1445.

The bus 1405 collectively represents all system, peripheral, and chipset buses that communicatively connect the numerous internal devices of the computer system 1400. For instance, the bus 1405 communicatively connects the processing unit(s) 1410 with the read-only memory 1430, the system memory 1425, and the permanent storage device 1435.

From these various memory units, the processing unit(s) 1410 retrieve instructions to execute and data to process in order to execute the processes of the invention. The processing unit(s) 1410 may be a single processor or a multi-core processor in different embodiments. The read-only-memory (ROM) 1430 stores static data and instructions that are needed by the processing unit(s) 1410 and other modules of the computer system 1400. The permanent storage device 1435, on the other hand, is a read-and-write memory device. This device 1435 is a non-volatile memory unit that stores instructions and data even when the computer system 1400 is off. Some embodiments of the invention use a mass-storage device (such as a magnetic or optical disk and its corresponding disk drive) as the permanent storage device 1435.

Other embodiments use a removable storage device (such as a floppy disk, flash drive, etc.) as the permanent storage device. Like the permanent storage device 1435, the system memory 1425 is a read-and-write memory device. However, unlike storage device 1435, the system memory 1425 is a volatile read-and-write memory, such as random access memory. The system memory 1425 stores some of the instructions and data that the processor needs at runtime. In some embodiments, the invention's processes are stored in the system memory 1425, the permanent storage device 1435, and/or the read-only memory 1430. From these various memory units, the processing unit(s) 1410 retrieve instructions to execute and data to process in order to execute the processes of some embodiments.

The bus 1405 also connects to the input and output devices 1440 and 1445. The input devices 1440 enable the user to communicate information and select commands to the computer system 1400. The input devices 1440 include alphanumeric keyboards and pointing devices (also called “cursor control devices”). The output devices 1445 display images generated by the computer system 1400. The output devices 1445 include printers and display devices, such as cathode ray tubes (CRT) or liquid crystal displays (LCD). Some embodiments include devices such as touchscreens that function as both input and output devices 1440 and 1445.

Finally, as shown in FIG. 14, bus 1405 also couples computer system 1400 to a network 1465 through a network adapter (not shown). In this manner, the computer 1400 can be a part of a network of computers (such as a local area network (“LAN”), a wide area network (“WAN”), or an Intranet), or a network of networks (such as the Internet). Any or all components of computer system 1400 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for offloading one or more data message processing services from a machine executing on a host computer, the method comprising:
at the machine:
using a set of virtual resources allocated to the machine to perform a set of services for a first set of data messages belonging to a particular data message flow;
determining that for a second set of data messages belonging to the particular data message flow, the set of services should be performed by a virtual network interface card (VNIC) that executes on the host computer and is attached to the machine; and
based on the determination, directing the VNIC to perform the set of services for the second set of data messages, wherein the VNIC uses resources of the host computer to perform the set of services for the second set of data messages.

2. The method of claim 1 further comprising:
determining that the set of virtual resources are no longer being over-utilized;
directing the VNIC to stop performing the set of services for the second set of data messages; and
performing the set of services for the second set of data messages using the set of virtual resources.

3. The method of claim 1 further comprising:
determining that the resources of the host computer are being over-utilized by the VNIC;
directing the VNIC to stop performing the set of services for the second set of data messages; and
performing the set of services for the second set of data messages using the set of virtual resources.

4. The method of claim 1, wherein:
the particular data message flow is a first data message flow; and
directing the VNIC to perform the set of services for the second set of data messages belonging to the first data message flow comprises directing the VNIC (i) to perform the set of services for the second data message flow and (ii) to forward data messages belonging to a second data message flow associated with the machine without performing the set of services for the second data message flow.

5. The method of claim 1, wherein the set of services comprises at least two of a firewall service, a load balancing service, an IPsec (Internet protocol security) service, and an encapsulation and decapsulation service.

6. The method of claim 5, wherein:
the firewall service comprises a connection tracking service; and
the IPsec service comprises an authentication service and an encryption service.

7. The method of claim 1 further comprising:
determining that a physical NIC (PNIC) of the host computer (i) is a smartNIC and (ii) is available to perform the set of services; and
directing the VNIC to offload the set of services to the PNIC to perform for the second set of data messages belonging to the particular data message flow.

8. The method of claim 1, wherein:
the set of services comprise stateful services; and
the machine maintains copies of state data for the second set of data messages while the VNIC performs the set of services for the second set of data messages.

9. The method of claim 1, wherein the host computer is a first host computer and the VNIC is a first VNIC, wherein the machine is migrated from the first host computer to a second host computer, the method further comprising:
saving state data for the set of services with the first VNIC on the first host computer; and
upon instantiating the machine on the second host computer, restoring the state data on a second VNIC on the second host computer, wherein when the state data is restored, the second VNIC continues to perform the set of services on the second set of data messages.

10. The method of claim 1, wherein the machine is a service virtual machine (SVM).

11. The method of claim 1, wherein determining that the allocated set of virtual resources is being over-utilized comprises determining that a particular quality of service (QoS) metric has exceeded a specified threshold value for that particular service.

12. The method of claim 1, wherein directing the VNIC to perform the set of services for the second set of data messages comprises providing to the VNIC (i) security session configuration data associated with the particular data message flow, (ii) security session state data associated with the particular data message flow, and (iii) a set of service rules defined for the particular data message flow.

13. The method of claim 12, wherein:
the security session configuration data, security session state data, and set of service rules are stored as a flow record in a cache of the VNIC;
a particular service component of the VNIC uses the flow record to perform the set of services for the second set of data messages; and
the particular service component of the VNIC updates the flow record for each data message in the second set of data messages processed by the VNIC.

14. A method for offloading one or more data message processing services to a virtual network interface card (VNIC) executing within virtualization software that executes on a host computer, the VNIC attached to a machine also executing within the virtualization software, the method comprising:
at a service engine executing within the virtualization software:
performing a set of services for a first set of data messages belonging to a particular data message flow;
determining that for a second set of data messages belonging to the particular data message flow, the set of services should be performed by the VNIC; and
based on the determination, directing the VNIC to perform the set of services for the second set of data messages, wherein the VNIC uses resources of the host computer to perform the set of services for the second set of data messages.

15. The method of claim 14, wherein:
the particular data message flow is a first data message flow; and
directing the VNIC to perform the set of services for the second set of data messages belonging to the first data message flow comprises directing the VNIC (i) to perform the set of services for the second data message flow and (ii) to call the service engine to perform the set of services for data messages belonging to a second data message flow associated with the machine.

16. The method of claim 14, wherein the set of services comprises at least two of a firewall service, a load balancing service, an IPsec (Internet protocol security) service, and an encapsulation and decapsulation service.

17. The method of claim 14 further comprising:
determining that a physical NIC (PNIC) of the host computer (i) is a smartNIC and (ii) is available to perform the set of services; and
directing the VNIC to offload the set of services to the PNIC to perform for the second set of data messages belonging to the particular data message flow.

18. The method of claim 14, wherein:
the set of services comprise stateful services; and
the service engine maintains copies of state data for the second set of data messages while the VNIC performs the set of services for the second set of data messages.

19. The method of claim 14, wherein directing the VNIC to perform the set of services for the second set of data messages comprises providing to the VNIC (i) security session configuration data associated with the particular data message flow, (ii) security session state data associated with the particular data message flow, and (iii) a set of service rules defined for the particular data message flow.

20. The method of claim 19, wherein:
the security session configuration data, security session state data, and set of service rules are stored as a flow record in a cache of the VNIC;
a particular service component of the VNIC uses the flow record to perform the set of services for the second set of data messages; and
the particular service component of the VNIC updates the flow record for each data message in the second set of data messages processed by the VNIC.
